(19) United States
(12) Patent Application Publication
(10) Pub. No.: US 2014/0352201 A1
(43) Pub. Date: Dec. 4, 2014

(54) MODIFIED FLYSWATTER DEVICE

(71) Applicant: Lucy Wegscheider, Lake Elmo, MN (US)

(72) Inventor: Lucy Wegscheider, Lake Elmo, MN (US)

(21) Appl. No.: 14/460,015

(22) Filed: Aug. 14, 2014

Related U.S. Application Data
(63) Continuation-in-part of application No. 13/461,640, filed on May 1, 2012, now abandoned.

(51) Int. Cl. A01M 3/02

(52) U.S. Cl. CPC A01M 3/022
USPC 43/137

(57) ABSTRACT

A fly swatter device to catch a plurality of bugs and insects that includes a traditional fly swatter that having an elongated handle with a distal end and a planar diagonal frame disposed on the distal end of the handle. A plurality of adhesive layers that are disposable and replaceable are disposed on the planar diagonal frame. In use, when a fly is caught on the outermost layer of one of the adhesive layers, that outer layer can be peeled-off and disposed of to expose the next adhesive layer for continue catching bugs and insects.

### CROSS REFERENCE TO RELATED APPLICATIONS

This application is a continuation in part of, incorporates by reference, and claims the benefit of co-pending U.S. patent application Ser. No. 13/461,640 filed May 1, 2012.

### BACKGROUND OF THE INVENTION

1. Field of the Invention

This invention relates generally to pest control instruments and, more particularly, to a modified fly swatter with a refreshable adhesive surface.

2. Description of the Prior Art

In warmer climates, flies or other flying insects often may slip into dwellings and create a nuisance. Under such circumstances, it is common for individuals to use conventional fly swatters or even rolled up papers to strike and kill the flies. The design and use of such conventional fly swatters is well known, generally consisting of a planar striking surface, typically shaped as a rectangle or circle and constructed of a lightweight, flexible, vented material, attached to an elongated handle. Hitting flies with such conventional fly swatters (or other apparatus), however, will generally leave behind a mess requiring clean up. Consequently, killing such insects and bugs can be a very messy process when such using a traditional apparatus.

Therefore, a problem which still exists is that existing fly swatter apparatus are generally only effective in smashing bugs against another surface and are unable to also catch bugs in mid air. Thus, there remains a need for a modified fly swatter device which would employ an adhesive surface for catching targeted insects in addition to simply smashing them. It would be helpful if such a modified fly swatter device employed a plurality of layers of removable adhesive layers to allow layers to be removed and disposed of. It would be additionally desirable for such a modified fly swatter device to employ a diagonal frame that enabled insects in corners structures to be more easily reached.

The Applicant's invention described herein provides for a modified fly swatter device adapted to allow a user to catch flies and other pest insects against an adhesive surface in addition to simply smashing them against another surface. The primary components in Applicant's modified fly swatter device are a planar diagonal frame, an elongated handle, and an adhesive layers surface. When in operation, the modified fly swatter device enables flies to be captured on a disposable adhesive surface, thereby providing for a cleaner and more sanitary removal of the pests. As a result, many of the limitations imposed by prior art structures are removed.

### SUMMARY OF THE INVENTION

The fly swatter device is a handheld device for killing insects and bugs. Comprised of a modified fly swatter with a handle, the fly swatter device has an adhesive surface attached to its planar frame. To use, simply strike and kill a desired bug or insect and peel away a replaceable planar sticky member layer to dispose of in the trash. The replaceable planar sticky members define the adhesive surface and provide for multiple uses of the fly swatter device. In this regard the fly swatter device features a modified insect swatter with a sticky, removable adhesive attached to its planar frame.

It is an object of this invention to provide a modified fly swatter device which would employ an adhesive surface for catching targeted insects in addition to simply smashing them.

It is another object of this invention to provide a modified fly swatter device that employs a plurality of layers of removable adhesive layers to allow layers to be removed and disposed of.

It is yet another object of this invention to provide a modified fly swatter device that employs a diagonal frame that enabled insects in corners structures to be more easily reached

It is still another object of this invention to provide a modified fly swatter device that is cleaner and more sanitary than a traditional fly swatter.

These and other objects will be apparent to one of skill in the art.

### BRIEF DESCRIPTION OF THE DRAWINGS

FIG. 1 is a front elevational view of the frame and handle of a modified fly swatter built in accordance with the present invention.

FIG. 2 is a front elevational view of a modified fly swatter built in accordance with the present invention.

FIG. 3 is a side elevational view of a modified fly swatter built in accordance with the present invention.

### DETAILED DESCRIPTION OF THE INVENTION

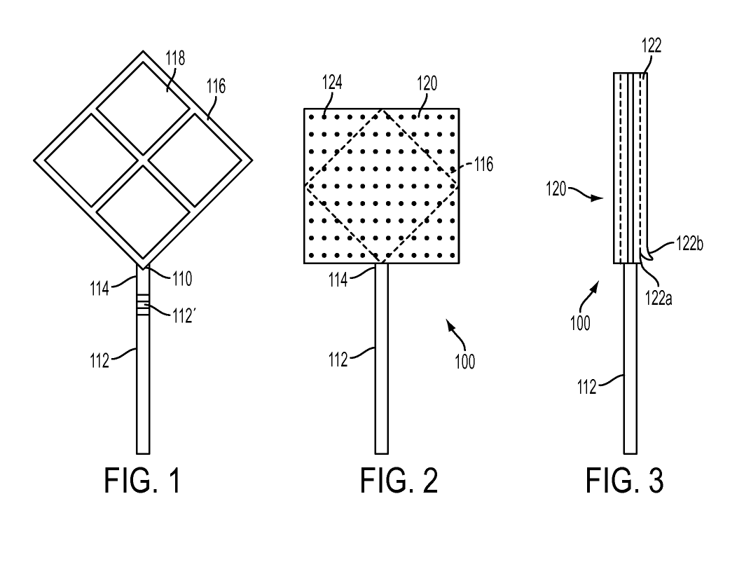

Referring now to the drawings and in particular FIGS. 1, 2, and 3, a modified fly swatter 100 is defined by a fly swatter base 110 with an adhesive layers surface 120. The fly swatter base 110 includes an elongated handle 112 with a distal end 114 and a planar diagonal frame 116 attached to the distal end 114 of the elongated handle 112. While it is contemplated that the planar diagonal frame 116 can be in other suitable shapes, such as a rectangle or a circle planar frame, it is understood that the diagonal shape, when used with rectangular adhesive layers 120, improves the ability of the adhesive layers surface 120 to reach into corners while still allowing the modified fly swatter 100 to maintain its structural form while being swung in the air or against a structure. The planar diagonal frame 116 includes four venting members 118 that allow air to freely pass through perforations 124 in the adhesive layers 120 when the modified fly swatter 100 is swung.

The plurality adhesive layers 120 are disposed on both the front side and the back side of the planar diagonal frame 116. Collectively, the adhesive layers surface 120 define a plurality of discrete, rectangular planar sticky members 122, each having a structure side 122a and a catching side 122b, layered on the planar diagonal frame 116. The structure side 122a is removably attached to the sticky member 122 immediately beneath (or, if the last layer, to the planar diagonal frame 116) and the catching side 122b is exposed for catching flies or other insects. Once a fly is caught on one of the outermost sticky members 122, it is peeled-off and disposed of, thereby exposing the next sticky member 122 that was disposed underneath the peeled-off planar sticky member 122. In this regard, the adhesive layers surface 120 provides discrete layers that are removable from the layer beneath it (or, if the last layer, from the planar diagonal frame 116) and disposable.

The sticky members 122 comprising the adhesive layers surface 120 each include a plurality of perforations 124 that are aligned throughout the plurality of adhesive layers 120 so as to allow air to freely pass through the venting members 118 of the planar diagonal frame 116. It is contemplated that a suitable planar sticky member 120 can define a dual side glue planar sticky surface, dual side fly paper planar sticky surface or any other similar dual side adhesive planar surface.

In the preferred embodiment, the adhesive layers surface 120 define a six (6) inch long, five (5) inch wide structure. In one embodiment, the handle 112 includes a telescopically extending area 112′ that allows it to be selectively increased in length. It is contemplated that the fly swatter device is designed to be available in a variety of colors and styles.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A modified fly swatter, comprising:
a fly swatter base defining an elongated handle with a distal end and a planar diagonal frame attached to the distal end, wherein said planar diagonal frame includes a front side and a back side;
an adhesive layers surface disposed on both the front side and the back side of the planar diagonal frame, wherein said adhesive layers surface defines a plurality of discrete, rectangular planar sticky members, each having a structure side and a catching side, disposed in layers on the planar diagonal frame in an orientation whereby the corners of the rectangular planar sticky members extend beyond the structural of the planar diagonal frame; and
wherein the structure side is removably attached to one of the sticky member immediately beneath and the planar diagonal frame the catching side is exposed for catching flies or other insects.

2. The modified fly swatter of claim 1, wherein the planar diagonal frame includes a plurality of venting members.

3. The modified fly swatter of claim 2, wherein the sticky members comprising the adhesive layers surface include a plurality of aligned perforations, thereby allowing air to freely pass through the venting members.
